(19) United States
(12) Patent Application Publication
(10) Pub. No.: US 2008/0175313 A1
(43) Pub. Date: Jul. 24, 2008

(54) METHODS OF ADAPTIVE ENCODING AND DECODING VIDEO SIGNALS

(75) Inventors: Ian Sinclair, Indian Falls, NY (US); Steven D. Smith, Rochester, NY (US); Vincent J. Ferrer, Macedon, NY (US); Paul J. Travers, Rochester, NY (US)

Correspondence Address: Stephen B. Salai, Esq.;Harter, Secrest & Emery LLP, 1600 Bausch & Lomb Place, Rochester, NY, 14604-2711, US

(73) Assignee: Icuiti Corporation, Rochester, NY (US)

(21) Appl. No.: 11/626,690

(22) Filed: Jan. 24, 2007

(51) Int. Cl. H04N 11/02

(52) U.S. Cl. 375/240.01; 375/E07.076

(57) ABSTRACT

A method of encoding video signals includes obtaining, averaging, offsetting, and replacing steps. In the obtaining step, a first value comprising a value of a video characteristic for a first portion of a first video signal and a second value comprising a value of the video characteristic for a second portion of a second video signal are obtained. In the averaging step, the first value and the second value are averaged to obtain an average value. In the offsetting step, the average value is offset by a first predetermined offset to obtain a first offset value and the average value is offset by a second predetermined offset to obtain a second offset value. In the replacing step, the first value is replaced with the first offset value on the first signal and the second value is replaced with the second offset value on the second video signal.

### BACKGROUND OF THE INVENTION

1. Field of the Invention

The present invention relates generally to encoding video signals comprising video content and control signals for display on a display screen and decoding the same video signals and control signals. More specifically, the invention relates to encoding video signals with information, for example, a mode of display of the video signals, such as 2D and 3D modes, on a display screen, and decoding the display signals to display the video content according to the encoded information.

2. Description of the Related Art

Numerous video display devices are known in the art for displaying video content. The video content displayed on these conventional display devices generally consists of a plurality of video signals of a known or readily ascertainable form. For example, NTSC video signals and MPEG-4 encoded video signals have become standard video formats that are well known in the art.

Increasingly sophisticated display devices have improved capabilities to display video content. For example, some display devices have become known that are capable of displaying three-dimensional images as well as two dimensional images. However, because not all content supplied to such display devices is capable of being displayed in three dimensions, there is a need in the art to provide display mode information and other control information along with video content to instruct the display that the content can be rendered in three dimensions so that the device can be switched between two dimensional and three dimensional modes.

Methods of providing a display device with attached information are proposed in U.S. patent application Ser. No. 11/470,985, entitled “Personal Video Display Device,” filed Sep. 7, 2006, and assigned to the same assignee as the present application. The disclosure of that application is hereby incorporated by reference.

However, there remains a need in the art for additional methods of encoding video content, and more specifically video signals, to provide display mode information to a video display device. There is also a need in the art for a method of encoding video signals with display mode information without noticeable degradation of image quality. Furthermore, there is a need in the art for a method of decoding content that has been encoded with display mode information for a video display device.

There also is a need for a method of encoding and decoding control information such as display mode information on the visible portion of video signals so that the control information remains available if the video signals are converted from one format to another.

### SUMMARY OF THE INVENTION

Applicants' present invention addresses the foregoing needs by providing methods of adaptive encoding and decoding of display mode information, and other information on the visible portion of video signals.

According to one aspect of the present invention, a method of decrypting a video signal includes a first reading step, a second reading step, a comparing step, a determining step, and an obtaining step. In the first reading step a first section for example, a first line of a video signal is read. In the second reading step, a corresponding second section for example a second line of a video signal is read. In the comparing step, the first section is compared to the corresponding second section to produce an output signal that depends on the comparison. In the determining step, a difference between the first section and the second section is determined from the comparison, the difference representing a data value. In the obtaining step, a plurality of data values are obtained over a number of video fields, the plurality of data values comprising preferably encoded instructions for displaying the video signal.

In accordance with the presently preferred embodiment of the invention, the first and second sections comprise portions of first and second lines of a single video field, and more preferably, discrete portions of first and second lines of the single video field

In another aspect of the invention, a method of encoding video content includes copying, determining, creating, and replacing steps. In the copying step, a portion of a first line of video content is copied. In the determining step, a signal characteristic value is determined for the copied portion of the first line of video content. In the creating step, and adjusted signal portion is created by adjusting, on the copied portion of the first line of video content, the signal characteristic value by at least a predetermined value. In the replacing step, a portion of a second line of video content corresponding to the portion of the first line of video content is replaced with the adjusted signal portion.

In a further aspect of the present invention, a method of encoding video signals includes obtaining, averaging, offsetting, and replacing steps. In the obtaining step, a first value comprising a value of a video characteristic for a first portion of a first video signal and a second value comprising a value of the video characteristic for a second portion of a second video signal are obtained. In the averaging step, the first value and the second value are averaged to obtain an average value. In the offsetting step, the average value is offset by a first predetermined offset to obtain a first offset value and the average value is offset by a second predetermined offset to obtain a second offset value. In the replacing step, the first value is replaced with the first offset value on the first signal and the second value is replaced with the second offset value on the second video signal.

An understanding of these and other features of the Applicants' invention may be had with reference to the attached figures and following description, in which the present invention is illustrated and described.

### BRIEF DESCRIPTION OF THE SEVERAL VIEWS OF THE DRAWINGS

FIG. 1 is a schematic diagram depicting data transfer between a video source and a personal video display device according to an embodiment of the invention.

FIG. 2 is a schematic flow chart illustrating an adaptive encoding method according to a preferred embodiment of the invention.

FIG. 3 is a schematic flow chart illustrating a decoding method according to a preferred embodiment of the invention.

FIG. 4 is a schematic diagram of a system according to a preferred embodiment of the invention.

### DETAILED DESCRIPTION OF THE PREFERRED EMBODIMENTS

Preferred embodiments of the invention now will be described with reference to the accompanying figures.

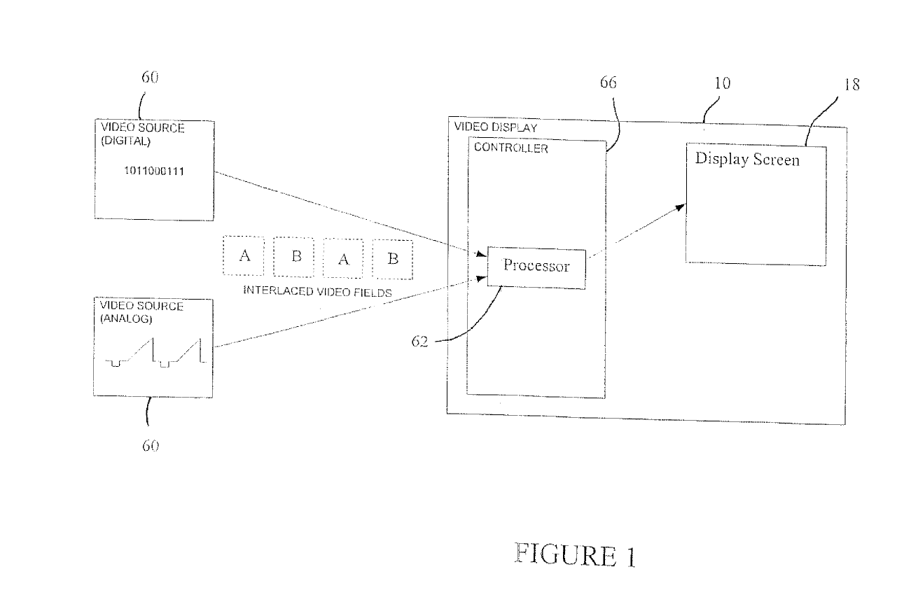

As illustrated in FIG. 1, a conventional image display device 10 displays an image on a display screen 18 from video content supplied by a video source 60. The video content comprises a plurality of video signals. The video signals may be supplied in either an analog format or a digital format, and the image display device 10 also may include a controller 66 and/or a processor 62 to accomplish display of the content. Frequently, in accordance with a commonly employed video format, the video signals include alternating, interlaced video fields A, B. When the described interlaced video fields A, B are displayed on a single display screen, the interlaced video fields are played in interlaced succession, A, B, A, B, . . . , to display a two dimensional video on the screen. (As will be appreciated, a combination of interlaced A and B fields comprises a frame, and a series of frames played in succession makes up the video. The fields may be played in succession B, A or in succession A, B to comprise a frame.)

By way of example, if the image illustrated in FIG. 1 is a 320 by 240 field, it is understood that the video consists of 240 lines, each having 320 pixels. Each of the A and B fields consists of 120 lines, such that interlaced combination of the A and B fields consists of 240 lines. Each A field contains all odd lines (namely, lines 1, 3, 5, . . . , 237, 239) and each B field contains all even lines (namely, lines 0, 2, 4, 6, . . . , 236, 238). Alternatively, the A field may consist of the even lines and the B field may consist of the odd lines. As is generally understood, each of the pixels making up the lines is a color sample having characteristics such as luminance, chrominance, hue, brightness, color, and the like.

As a standard format, the video content containing the A and B fields may be supplied to the display device as standard NTSC content. More likely, however, the NTSC analog signals are decoded to YCrCb digital video data before being displayed on the display device. Regardless of the form of the video signals, the present invention provides methods for encoding video content with information that may be used, for example, to appropriately display the video content on a display device.

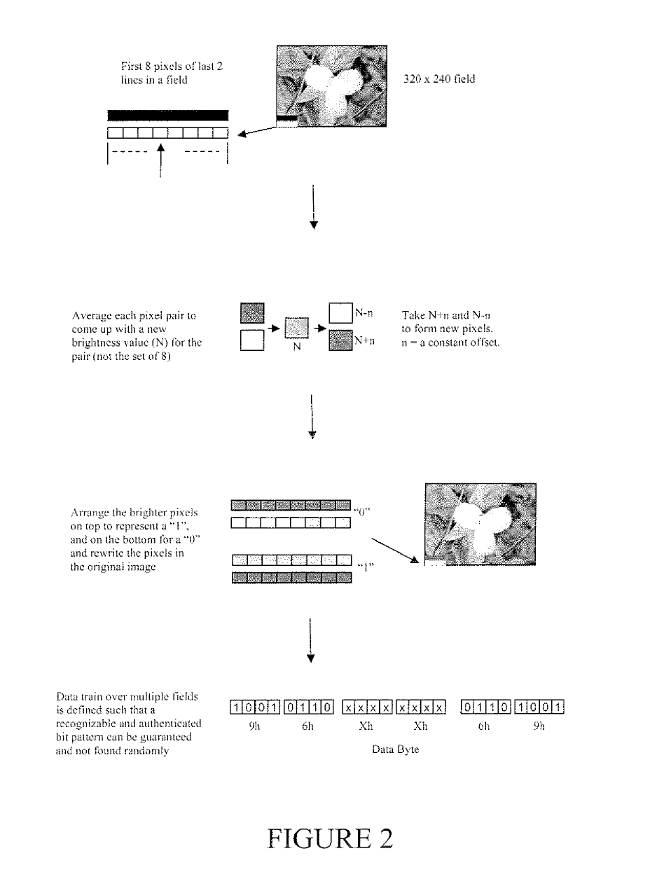

In a first preferred embodiment of the invention, a method of encoding video content such as described above includes altering the last two lines of a frame, namely, lines 239 and 240 of a frame described above. As illustrated in FIG. 2, video signals are encoded with control information by altering the first 8 pixels of each of the last two lines in a frame (and thus the last line of each A or B field). More specifically, in the preferred embodiment, one or more characteristics of each of the first eight pixels of line 238 and one or more characteristics of each of the first eight pixels of line 239 are altered to create a relationship between the encoded signals from which relationship the control data may be decoded. For example, the first pixel of line 238 may be altered such that a characteristic thereof is intentionally made to be greater than or less than the same characteristic of the first pixel of line 239. For example, the luminance of the first pixel of line 238 may be made greater (or less) than the luminance of the first pixel of line 239.

Each of the first 8 pixels of lines 238 and 239 preferably are altered in the same manner as the first pixels, described above. In particular, it is preferred that the second pixel of line 238 and the second pixel of line 239 are altered in the same way described above for the first pixel. Similarly, the 3^{rd}, 4^{th}, 5^{th}, 6^{th}, 7^{th}, and 8^{th} pixels of lines 238 and 239 similarly are differentiated. Accordingly, eight pixel pairs are provided, each with the same predetermined difference in one or more characteristic. As will become apparent from the following description, it is also preferred that the difference for each pixel pair is substantially the same. Thus, if in the first pixel pair the characteristic of the pixel in line 238 is greater than the characteristic of the corresponding pixel in line 239, the same characteristic of the second through eighth pixels in line 238 also should be greater than the characteristic of the respectively corresponding pixels in line 239.

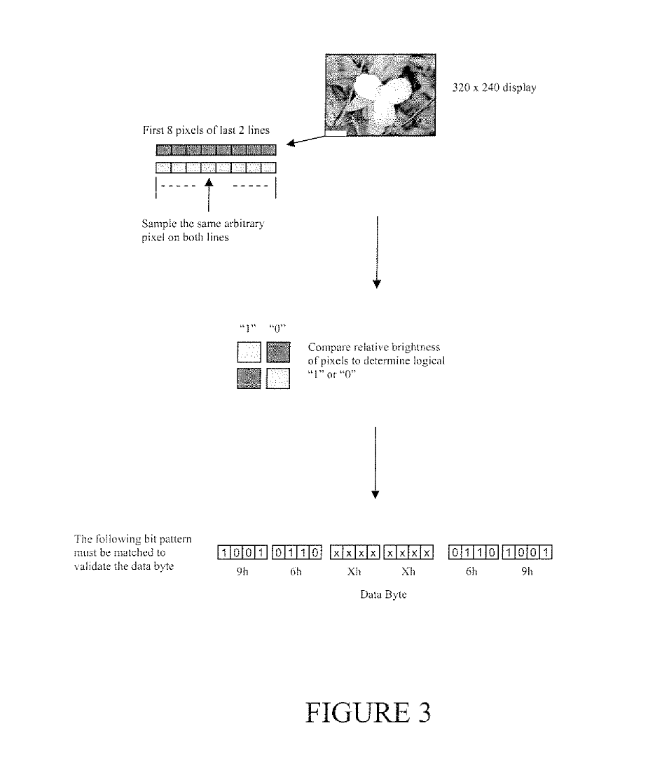

The pixel pairs for the first eight pixels of lines 238 and 239 are altered as described above in a way that is readable by a decoder. Specifically, and as illustrated schematically in FIG. 3, the decoder compares at least one of the pixel pairs to determine whether the altered characteristic(s) is/are greater in line 238 or line 239, and takes from that comparison a piece of data. In the preferred embodiment, for example, the decoder preferably determines that when the characteristic of one of the first eight pixels of line 238 is less than the same characteristic of the corresponding pixel on line 239, a binary value of 1 is read by the decoder. Alternatively, when the value of a characteristic of one of the first eight pixels of line 238 is greater than the value of the same characteristic of the corresponding pixel in line 239, a binary value of 0 is determined. Thus, with each frame played by the digital video recorder, the decoder obtains from the video signals a single bit, either a binary 1 or a binary 0. Over a series of frames, a data stream of binary 1's and 0's is obtained. This data stream may contain any number of instructions for the video display device along with optional identifying information, error checking information, or the like. While the data stream may only be placed over a select number of frames, it is preferable that every frame of video content is encoded as described, such that the necessary information is continually obtainable, for example, in the case of a video being started from some place other than the beginning.

According to the foregoing, it should be apparent that it is only necessary for a single pixel pair to be considered by the decoder to determine the data bit for each frame. However, as mentioned above, it is desirable that each of the eight pixel pairs be altered to have the same relationship therebetween. Specifically, the inventor's have found that by altering each of the first through eighth pixels in the same manner, the decoder need not accurately choose a single one of the pixels. So long as the decoder chooses the same pixel in line 238 as in line 239, the required difference in characteristics between the two lines will be obtained and thus the required data will be decoded from the video signal. It is only required that the decoder reads some pixel within the first through eighth pixels, and that it reads the same pixel from each line. In fact, the inventor's have found it to be occasionally difficult on conventional display devices for a decoder to exactly choose some pixel (e.g., the first pixel, the tenth pixel, etc.) on a line. However, once a pixel has been chosen on a first line, it is relatively easy to choose the same pixel on the second line. Thus, it is not necessary that the decoder know which of the first through eighth pixels it has chosen, only that it chooses a pixel within that range.

As described above, any one or more of a number of video characteristics may be altered to obtain the desired difference between pixels on the adjacent lines 238 and 239. That is, alteration of many different characteristics may result in the discernable difference read by the decoder. These characteristics may include luminance, chrominance, color, brightness, hue, or the like. Of course, by altering any of these characteristics for the 8 pixels in each of lines 238 and 239, the image displayed by the video display device will necessarily be altered. In an extreme example, if it was decided that the decoder would detect a binary “1” when the pixel in line 238 is white and the corresponding pixel in line 239 is black, and the decoder would detect a binary “0” when the pixel in line 238 is black and the corresponding pixel in line 239 is white, each frame would contain a thin strip of two lines by eight pixels wide of either a white strip over a black strip or a black strip over a white strip. When in the preferred embodiment, a series of frames is encoded to provide the decoder with a data stream, this strip would be visible to the human eye. More preferably, the encoding is done over the entire video content, such that any information to be conveyed by the data may be obtained by the video display device regardless of whether the video content is started from the beginning or some later point, and thus the thin strips would be visible over the entire video.

Most likely, two adjacent lines will have very similar characteristics, for example, when a portion of the display including both of the adjacent lines is of a similar color or generally shows the same objects. In some circumstances, however, the adjacent lines may have quite different characteristics, for example, when the display includes horizontal lines that would fall on the adjacent lines.

The present invention features an adaptive encoding technique, whereby the visibility of the encoding to an ordinary observer is minimized. This technique will be described with reference to FIG. 2. As shown therein, when brightness is the characteristic to be altered (and subsequently read by a decoder), the brightness of the first pixel in line 238 and the brightness of the first pixel in line 239 are determined. Using this difference, an average brightness value N is determined for the pair of pixels. Line 238 and line 239 are then encoded such that the first pixel in line 238 and the first pixel in line 239 have a brightness value equal to the average brightness offset by some predetermined offset brightness n. Preferably, both the pixel in line 238 and the pixel in line 239 are offset, one in the negative direction (i.e., the pixel is made less bright by the predetermined offset brightness n), and one in the positive direction (i.e., the pixel is made brighter by the predetermined offset brightness n), thus providing a total offset of 2n. According to the preferred embodiment described above, when it is desired that the pair of pixels represent a binary “1”, the pixel in line 238 is brightened, i.e., by offsetting the average brightness N by addition of the constant offset n, and the pixel in line 239 is made relatively less bright, i.e, by offsetting the average brightness N by subtraction of the constant offset n. Similarly, when it is desired that the pixel pair represent a binary “0”, the pixel in line 239 is made relatively brighter than the corresponding pixel in line 238. Of course, the arrangement of the corresponding pixels may be switched if the encoder decides that the binary “1's” and “0's” are to be switched.

The above described manipulation of the pair of pixels arranged in line 238 and line 239 is done for each of the first eight pixels in lines 238 and 239 as described above. The inventors have found that by averaging each pair of pixels and offsetting that average by the constant offset n, image quality degradation caused by changing the brightness is minimized. It would also be possible to take an average of the eight pixels in line 238 and an average of the eight pixels in line 239, and then average those values to determine the average value N. Of course, this would make all of the eight pixels in line 238 have an identical brightness value and all of the eight pixels in line 239 have an identical brightness value, offset relative to the pixels in line 238. Groups of two or more pixels may be altered in a similar manner.

As will be understood by those of ordinary skill in the art, the lower the constant offset n, the less visible degradation in image quality will occur. However, the inventors have found that the offset should be at least a minimum offset to ensure proper differentiation between the pixels comprising the pixel pair during decoding. In particular, the inventors have found that an offset n of from about sixteen to about twenty-four on a scale of 0 to 255 provides a sufficient buffer, which allows the decoder to appropriately distinguish between the pixels.

Other methods of offsetting the pixels to arrive at the desired difference therebetween also are contemplated. For example, instead of taking an average of each pixel pair and then offsetting that average for each of the pixels, the average brightness value N may be used as either the more or less bright pixel, with the other pixel being offset upwardly or downwardly with respect thereto. Moreover, in an alternative configuration an encoder could determine the characteristic of the pixel in line 238 and offset that same characteristic in the corresponding pixel in line 239 either upwardly or downwardly to achieve the same result. Of course, the same could be achieved by offsetting a characteristic value in line 238 with respect to 239, while leaving the pixel in line 238 unchanged. In this manner, information in only one line is offset, and no average need be taken. For example, this method of offsetting may be particularly useful when the pixels are at or near the upper or lower limit. More specifically, in an example in which both pixels are black, it would not be possible to darken either pixel. Instead, one pixel preferably remains unchanged, while the other pixel is offset by some discernable amount.

According to the encoding scheme described to this point, a digital signal preferably is encoded to produce a discernible difference between a pixel or group of pixels in a first line on a first field and a corresponding pixel or group of pixels in an adjacent second line on a second field. In an alternative embodiment, however, the video signal may be encoded such that the discernible difference is indicated on lines of the same field, i.e., on lines 237 and 239, on lines 236 and 238, and the like. The difference is preferably accomplished in the same manner as described above.

As a result of any of the foregoing methods for encoding the video content, the digital signals displayed in two lines of a video display are encoded such that a difference exists between a pixel in the first line and a corresponding pixel in the second line. Preferably, the difference is interpreted by a decoder to represent one of a binary “0” and binary “1”. In this manner, when adjacent lines on successive fields are encoded as described above, each frame of video content is interpreted by the decoder as either a binary “1” or a binary “0”, and a data stream may be obtained for a series of frames. Similarly, when two lines on the same field are encoded as described above, each field of video content is interpreted by the decoder as either a binary “1” or a binary “0”, and a data stream may be obtained for a series of fields. Alternatively, two data streams may be obtained when each field represents either a binary “1” or a binary “0”, e.g., one data stream consisting of the A field values and one data stream consisting of the B field values. Such data streams preferably represent to the decoder any of a number of types of information. For example, the information may provide the display device with instruction to display the images in a 2-D format or in a 3-D format. Moreover, the 3-D format may be a regular 3-D format or a reverse 3-D format. Other information including, but not limited to, formatting information (e.g., 4:3, 16:9, stretch, letterbox, and the like), brightness information, contrast information, and/or video display information, may alternatively, or additionally, be contained in the data streams.

As should be appreciated, the data stream may be manipulated to output any string of binary code, i.e., by manipulating pixel characteristics in a series of frames or fields. However, because the decoder is reading a portion of a first eight pixels of two lines, there is the potential that non-encoded content may result in the decoder reading a difference, for example, a difference in brightness between corresponding pixels in two lines. This also creates the potential that non-encoded video content displayed by a video display device could randomly generate what is perceived by the decoder to be information relating to the display of the video content. More specifically, consider an example in which the data stream “0, 1, 0, 1, 0, 1” signifies to a display device that video content is to be displayed three-dimensionally. If content is un-encoded and six successive frames (or fields) randomly result in a decoder obtaining the aforementioned data stream, the device will attempt to display the content in three-dimensions even though the content is not formatted for three-dimensional display.

The present invention provides a recognizable and authenticated bit pattern that is substantially unlikely to be found randomly. In particular, the data stream according to the preferred invention preferably includes an 8 bit start sequence and an 8 bit stop sequence in between which the information to be conveyed to the player is encoded. Accordingly, only upon recognition of both the start and stop sequence will the decoder look for data following the start signal, and only when that data is followed by the predetermined stop signal will the encoded data be recognized and used to configure the device. In the preferred embodiment, the start sequence is a hexadecimal 9, ×9, followed by a hexadecimal 6, ×6, and the stop sequence is an ×6 followed by an ×9. Thus, as illustrated in FIGS. 2 and 3, the first eight bits (the start sequence) of an information-containing data stream are “1, 0, 0, 1, 0, 1, 1, 0”, and the last eight bits (the stop sequence) of the data stream are “0, 1, 1, 0, 1, 0, 0, 1.” The information contained within the start sequence and the stop sequence may be any number of bits. Eight bits are used in FIG. 5 for illustrative purposes only. Moreover, the start and stop bit patterns may be of any pattern, as will be appreciated by one of ordinary skill in the art.

In the preferred embodiment, the complete data stream, including the start and stop sequences and the information therebetween, consists of 24 bits of information. When each bit corresponds to one frame of video content, i.e., when lines 238 and 239 are altered to produce the desired difference, it is possible to recognize information relating to the display of the video signals in less than half of a second from the start of the start sequence (assuming the content is displayed at 60 frames/second). When two lines on each field are altered to produce a discernible difference, it may be possible to recognize information relating to the display of the video signals in even less time. Accordingly, any adjustments to be made to the picture resulting from interpretation of the acquired information may be quickly instituted. This is particularly beneficial in instances in which the information relates to a method or mode of displaying the video content. If a video is for example to be displayed in 3-D, the video display device will make this realization within a very short period of time, and the user's enjoyment of the video will be relatively uninterrupted. Shorter data streams may allow for quicker recognition of information, but are more likely to be randomly generated, while longer data streams may be used to reduce the likelihood of random generation, but the recognition of information takes longer

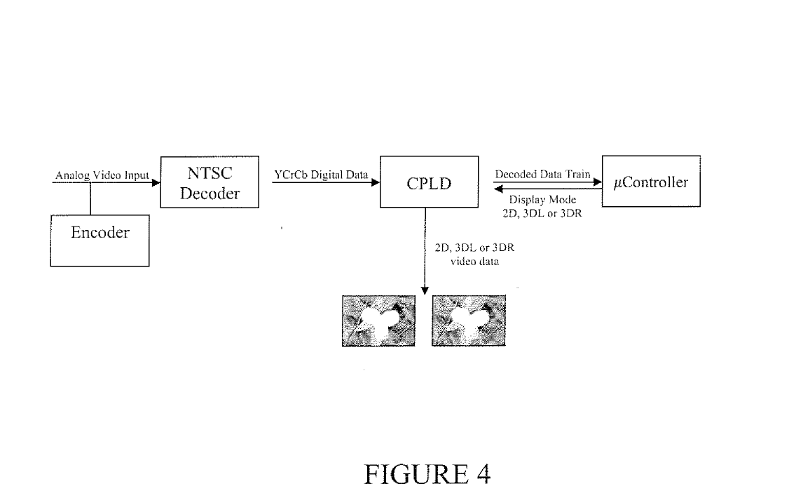

FIG. 4 illustrates a computing system employing the above-identified encoding and decoding systems. As shown therein, previously encoded analog video signals are put into an NTSC decoder which decodes the analog video and outputs YCrCb digital video data. This digital data carries the previously encoded information described above, and is input into a complex programmable logic device (CPLD). The CPLD extracts the encoded information from the video signal in the manner described above, and provides a digital data stream to a microcontroller. The microcontroller then decodes the information conveyed by the data stream to alter the display of the video signals. In one example, the microcontroller may instruct the display device to display the video signals in one of a 2-D, 3-D, or reverse 3-D manner.

An exemplary decoding algorithm for use by the CPLD is as follows:

```
    if ((inputcount[9:0] == 10′d30))
    begin
        if (linecount == 8′d242)
            RefPixel <= YCrCb_in[15:8];
        else if (linecount == 8′d243)
            DiffPixel <= RefPixel − YCrCb_in[15:8];
    end
    data_out <= DiffPixel[8];
inputcount is the pixel counter starting at the end of Hsync
linecount is the number of lines starting a few lines before
active video (Needed to meet timing for the display)
YCrCb_in is the raw data from the decoder where the upper 8 bits
is the Y data
RefPixel holds the pixel on line 239
DiffPixel holds the difference in Y value from 239 to 240
data_out is the data signal to the microcontroller
```

An exemplary software routine for the microcontroller to decode the information received from the CPLD is as follows:

;************************************************************
*****
; handle_CPLD
; This routine decodes the bitstream which the CPLD extracts from
; the source video.
;************************************************************
*****
handle_CPLD

| movf PORTA,w | | ; latch PORTA |
|---|---|---|
| bcf | INTCON,RABIF | ; clear the interrupt |

| | |
|---|---|
| btfscPORTA,CFLD_CLK | ; if the clock line is low, set up |
| out bit | |
| goto handle_CPLD_IN | ; otherwise clock in a bit |

```
handle_CPLD_OUT
    movf Bit_Out_Count,f
    btfscSTATUS,Z
    return
    decf Bit_Out_Count,f
```

| | |
|---|---|
| rlf | Cmd_3D,f |

```
    btfssSTATUS,C
    goto CPLD_OUT_LOW
CPLD_OUT_HIGH
```

| | |
|---|---|
| banksel | PORTA |
| bsf | PORTA,CPLD_OUT |
| return | |

CPLD_OUT_LOW

| | |
|---|---|
| banksel | PORTA |
| bcf | RORTA,CPLD_OUT |
| return | |

```
handle_CPLD_IN
    incf Bit_Count,f
    movf PORTA,w
```

| | |
|---|---|
| andlw4h | ; mask off the CPLD in bit |

```
    btfssSTATUS,Z
    goto CPLD_IN_HIGH
CPLD_IN_LOW
```

| | |
|---|---|
| bcf | STATUS,C |

goto shift_CPLD_IN
CPLD_IN_HIGH

| | |
|---|---|
| bsf | STATUS,C |

shift_CPLD_IN

| | |
|---|---|
| rlf | CPLD_Byte,f |

```
    movf State_3D,w
    btfscSTATUS,Z ;  check if 3D state 0
    goto chk_state_3D_0
    movf Bit_Count,w
    sublw8h
    btfssSTATUS,Z
    return
    movf State_3D,w
    sublw1h ;  check if 3D state 1
    btfscSTATUS,Z
    goto chk_state_3D_1
chk_state_3D_2
    movf CRLD_Byte,w
    sublw69h
    btfssSTATUS,Z
    goto CPLD_STATE_ERROR
    ; we have the valid end of message byte so...
    nop
    movlw8h
    movwfBit_Out_Count
    goto CPLD_STATE_ERROR
chk_state_3D_1
    movfCPLD_Byte,w
    movwf Cmd_3D
    incf State_3D,f
    goto done_handle_CPLD
chk_state_3D_0
    movf CPLD_Byte,w
    sublw0x96
    btfssSTATUS,Z
    return
    nop
    incf State_3D,f
    goto done_handle_CPLD
CPLD_STATE_ERROR
    clrf State_3D
    clrf CPLD_Byte
done_handle_CPLD
    clrf Bit_Count
    return
```

Although the preferred embodiments of the invention have been described with reference to a 320×240 field, the invention may be used with fields of any size, including, but not limited to, 640×240, 640×480, and the like. Moreover, although the invention describes manipulating pixels in the last two lines of a frame, any lines may be used. Moreover, the limes may be adjacent, as in lines 238 and 239, or spaced from each other.

Although the first eight pixels are described in the preferred embodiment as being manipulated in the preferred embodiments, more or less pixels than eight may be modified. In addition, the pixels may be anywhere along the line, not just the first eight pixels. The location of the modified pixels in the preferred embodiment generally is chosen because it is on the periphery of the display field, where any perceptible modifications will be least obtrusive for a viewer. More or less than 8 pixels also may be manipulated to achieve the ends of the invention.

Although the invention has been described as providing a difference between corresponding pixels in two lines, more than two lines may also be encoded. For example, an average N may be taken of a characteristic of corresponding pixels in lines 237, 238 and 239. In this embodiment, a binary “1” or “0” may be represented by setting the characteristic of the pixel in line 238 to correspond to the value N, offsetting the same characteristic in the corresponding pixel in line 237 by increasing or decreasing the value N by an offset n, and correspondingly decreasing or increasing the same characteristic of the corresponding pixel in line 239. As will be understood, as more lines are used, more comparisons may be made, providing additional certainty in the decoder. However, as more lines are affected, there is a greater possibility that the encoding will be perceptible by a viewer of the video content.

As described above, two lines on the same or successive fields may provide a bit of data in a data stream. In an alternative embodiment, additional pixels may be encoded according to the invention to provide more than one bit of data per frame or field. For example, a binary “1” or “0” may be ascertained from lines 238 and 239 as described above, while two other lines (e.g., lines 1 and 2) are encoded to contain another piece of information, e.g., another binary “1” or “0”, used in a separate data stream. In this manner, additional information may be transmitted in a relatively shorter amount of time.

In another embodiment of the invention, the start and stop sequence described above for minimizing the likelihood that a data stream will be randomly generated may be altered. In particular, a cyclical redundancy check may additionally be used, or in place of one or both of the start and stop sequence. For example, the stop sequence may be replaced with an 8-bit cyclical redundancy check. Such an arrangement has been found to aid in reducing false positives obtained using the arrangement described above.

The foregoing embodiments of the invention are representative embodiments, and are provided for illustrative purposes. The embodiments are not intended to limit the scope of the invention. Variations and modifications are apparent from a reading of the preceding description and are included within the scope of the invention. The invention is intended to be limited only by the scope of the accompanying claims.

1. A method of decrypting a video signal, comprising:
a first reading step of reading a first section of a first line of a video signal;
a second reading step of reading a corresponding section of a second line of a video signal;
comparing the first section of the first line to the corresponding section of the second line;
determining, from the comparison, a difference between the first section and the corresponding section, the difference representing a data value; and
obtaining a plurality of the data values over a number of video fields, the plurality of data values comprising instructions for displaying the video signal.

2. A method according to claim 1, wherein the first section is a number of pixels.

3. A method according to claim 2, wherein the corresponding section is a number of pixels.

4. A method according to claim 3, wherein the first line and the second line are adjacent lines.

5. A method according to claim 1, wherein the first line and the second line are rows of pixels displayed on a video display device.

6. A method of encoding video content, comprising:
(a) copying a portion of a first line of video content;
(b) determining a signal characteristic value for the copied portion of the first line of video content;
(c) creating an adjusted signal portion by adjusting, on the copied portion of the first line of video content, the signal characteristic value by at least a predetermined value; and
(d) replacing a portion of a second line of video content corresponding to the portion of the first line of video content with the adjusted signal portion.

7. The method of encoding according to claim 6, wherein the portion of the first line of video content is between eight and twenty-four pixels.

8. The method of encoding according to claim 6, wherein the signal characteristic is one of luminance, chrominance, color, hue, and brightness.

9. The method of encoding according to claim 8, wherein the signal characteristic is increased by at least the predetermined value to indicate one of a binary “0” and a binary “1” and the signal characteristic is decreased by at least the predetermined value to indicate the other of the binary “0” and the binary “1”.

10. The method of encoding according to claim 6, wherein the first line of video content and the second line of video content are adjacent horizontal lines in the same frame.

11. The method of encoding according to claim 6, wherein the first line of video content is contained in a first field and the second line of video content is contained in a second field.

12. The method of encoding according to claim 6, wherein the first line and the second line are displayed in a first frame, and the adjusted signal portion provides a signal characteristic differentiation between the first line and the second line, the method further comprising the steps of:
(e) performing steps (a) through (d) a plurality of times to provide a signal characteristic differentiation for each of a plurality of successive frames, the signal characteristic differentiation for the plurality of successive frames being readable to form a data stream.

13. The method of encoding according to claim 12, wherein the signal characteristic differentiation is readable as a binary value, the data stream therefore comprising a series of binary values.

14. The method according to claim 12, wherein the data stream comprises information relating to the video content.

15. The method according to claim 14, wherein the data stream comprises information relating to whether the video content is to be displayed as one of two-dimensional video content and three-dimensional video content.

16. A method of encoding video signals comprising:
obtaining (i) a first value comprising a value of a video characteristic for a first portion of a first video signal and (ii) a second value comprising a value of the video characteristic for a second portion of a second video signal;
averaging the first value and the second value to obtain an average value;
offsetting (i) the average value by a first predetermined offset to obtain a first offset value and (ii) the average value by a second predetermined offset to obtain a second offset value;
replacing (i) the first value with the first offset value on the first signal and (ii) the second value with the second offset value on the second video signal.

17. The method according to claim 16 wherein the first portion of the first video signal is a pixel on a first line of video content and the second portion of the second video signal is a pixel on a second line of video content.

18. The method according to claim 16, wherein the video characteristic is one of a luminance, chrominance, hue, color, and brightness.

19. The method according to claim 16, the first video signal comprises a first field and the second video signal comprises a second field, the first field and the second field comprising a frame, wherein the obtaining, averaging, offsetting and replacing steps are done for a plurality of frames to be displayed in succession.

20. The method according to claim 19, wherein a difference between the first offset value and the second offset value represents a data value such that a data string is encoded over a plurality of frames.

21. A method of encoding control information on a visible portion of the video signal comprising:
determining a value of a selected first visible portion of the video signal;
determining the value of a selected second visible portion of the video signal;
determining the value of the control information to be encoded on the video signal; and
adjusting the difference between the value of the selected first portion and the value of the selected second portion in accordance with the value of the control information.

22. The method of encoding control information of claim 21 in which the step of determining the value of a selected first visible portion of the video signal comprises determining the value of a selected portion of a first line of the video signal, and the step of determining the value of a selected second visible portion of the video signal comprises determining the value of a selected portion of a second line of the video signal.

23. The method of encoding control information of claim 22 in which the step of adjusting the difference between the value of the selected first portion and the value of the selected second portion comprises copying the selected portion of a first line plus the adjustment to the selected second portion.
